(19) United States
(12) Patent Application Publication
(10) Pub. No.: US 2014/0091603 A1
(43) Pub. Date: Apr. 3, 2014

(54) QUICK-RELEASE ANCHORING DEVICE FOR A BICYCLE SADDLE OR THE LIKE

(71) Applicant: TIEN HSIN INDUSTRIES CO., LTD., Taichung City (TW)

(72) Inventor: Roberto Monaco, Trento (IT)

(73) Assignee: TIEN HSIN INDUSTRIES CO., LTD., Taichung (TW)

(21) Appl. No.: 14/122,960

(22) PCT Filed: May 24, 2012
(86) PCT No.: PCT/IB2012/052614

§ 371 Date: Nov. 27, 2013

(30) Foreign Application Priority Data
May 27, 2011 (IT) TN2011A000004
Sep. 30, 2011 (IT) TN2011A000006
Jan. 25, 2012 (IT) VR2012A000014

(51) Int. Cl. B62J 1/08

(52) U.S. Cl. CPC B62J 1/08
USPC 297/195.1

(57) ABSTRACT

The present invention relates to an anchoring device for anchoring a bicycle saddle to a seatpost. The anchoring device comprises a first component adapted to receive a frame of the saddle, a second component detachable fixed on the first component for holding the frame of the saddle, and a third component adapted to be fixed to the seatpost. The first component and the third component are detachably mounted to each other in a male-female manner that allows a quick release of the saddle from the seatpost.

### BACKGROUND OF THE INVENTION

1. Field of the Invention

The present invention relates to an anchoring device, and more particularly, to a quick-release anchoring device for a saddle of a bicycle or the like.

2. Description of Related Art

The use of bicycle as a means of transport is increasingly popular, especially in urban areas, both because the bicycle is a cheap and green means of transport, and because, due to environmental reasons, some areas are closed to traffic or provide for limitations to the entrance of motor vehicles but at the same time always allow access for pedestrians and bicycles.

A problem that places parking stations for bicycles, and parked bicycles in general, is the theft of bicycle parts and in particular the theft of the bicycle saddle. The theft of the saddle makes the bicycle unusable in practice, forcing the owner to buy a new saddle.

Hence the present invention overcome the technical problem of providing a device for anchoring a saddle to a frame of a bicycle, which allows to overcome the drawback mentioned above with reference to the known and/or to achieve further advantages.

### SUMMARY OF THE INVENTION

To be more specific, the anchoring device according to the present invention implements a quick-release system for the saddle, which allows the user to easily release the saddle, for any eventuality, without a need for tools and without the risk of tampering with or altering the setting of the coupling of the saddle itself.

This allows the owner of the bicycle to carry the saddle with him/her, when he/she is not using the bicycle, or to secure the saddle with the bicycle to a bike rack using a chain padlock. Therefore, the theft of the saddle is prevented. The subject of the present invention has the advantage of limiting the saddle thefts that are a common occurrence by now.

Some advantages of the subject of the present invention are listed below:

Firstly, the anchoring device is cheap and easy to make, not requiring special techniques;

Secondly, the anchoring device is easy to assemble, as well as easy and simple to use for anyone;

Thirdly, the anchoring device has features which are similar to the standard coupling device, but with the specific feature of the quick release;

Fourthly, the anchoring device can be adapted to most seatposts/pillars already on the market, which therefore could be sold already equipped with the quick-release kit/system;

Further advantages, features and the modes of use of the subject of the present invention will be apparent from the following detailed description of preferred embodiments thereof, given by way of a non-limiting example.

It is however evident that each embodiment of the subject of the present invention may have one or more of the advantages listed above; in any case, however, it is not required that each embodiment has concurrently all the listed advantages.

Reference will be made to the figures of the accompanying drawings.

### BRIEF DESCRIPTION OF THE DRAWINGS

FIG. 1 shows a side perspective view of an anchoring device according to the present invention, mounted in a configuration used to connect a saddle to a seatpost;

FIG. 2 shows a view with partially detached parts of the device of FIG. 1;

FIG. 3A shows a schematic rear perspective view, the device of FIG. 1 in a step of releasing the saddle from the seatpost;

FIG. 3B shows a schematic rear perspective view, the device of FIG. 1 in a step of coupling or anchoring the saddle to the seatpost;

FIG. 4 shows a side perspective view of a different embodiment of the device of FIG. 1 with partially detached parts;

FIG. 5 shows, in a side view with parts detached, the device of FIG. 4 from which some parts have been removed;

FIG. 6A shows, in a side perspective view with parts detached, the device of FIG. 4 from which some parts have been removed;

FIG. 6B shows, in a second side view with parts detached, the device of FIG. 4 from which some parts have been removed;

FIG. 7 shows a bottom view of a component of the device of FIG. 4;

FIGS. 8A and 8B show two side perspective views of another component of the device of FIG. 4;

FIG. 9A shows, in a rear perspective view with partially detached parts, another different embodiment of the device of FIG. 1;

FIG. 9B shows, in a side perspective view with parts detached, the device of FIG. 9A from which some parts have been removed;

FIG. 10 shows an overall front perspective view of another embodiment of the anchoring device according to the present invention;

FIG. 10A to 10E respectively show front, rear, right, top and bottom views of the device of FIG. 10;

FIG. 10F shows a sectional view, according to the section line X-X in FIG. 10D, of the device of FIG. 10;

FIG. 11 shows a rear perspective view of a first component of the anchoring device of FIG. 10;

FIGS. 11 A to 11 E respectively show front, rear, top, bottom and right views of the first component of FIG. 11;

FIG. 11 F shows a sectional view, according to the section line XI-XI in FIG. 11 C, of the first component of FIG. 11;

FIG. 12 shows a perspective view of a second component of the anchoring device of FIG. 10;

FIG. 12A to 12D respectively show left, front, top and bottom views of the second component of FIG. 12;

FIG. 13 shows a sectional view, according to the section line XIII-XIII in FIG. 12C, of the second component of FIG. 12;

FIG. 14 shows a bottom perspective view of a third component of the anchoring device of FIG. 10;

FIG. 14A to 14F respectively show front, rear, top, bottom, right and left views of the third component of FIG. 14;

FIGS. 15A and 15B show sectional views, according to respective section lines XVa-XVa and XVb-XVb in FIG. 14C, of the third component of FIG. 14;

FIG. 16 shows a perspective view of a fourth component of the anchoring device of FIG. 10;

FIG. 16A to 16D respectively show front, top, bottom and left views of the fourth component of FIG. 16;

FIGS. 17A and 17B show sectional views, according to respective section lines XVIIa-XVIIa and XVIIb-XVIIb in FIG. 16B, of the fourth component of FIG. 16;

FIG. 18 shows a perspective view of a fifth component of the anchoring device of FIG. 10;

FIGS. 18A and 18B respectively show top and side views of the fifth component of FIG. 18;

FIG. 19 shows a perspective view of a sixth component of the anchoring device of FIG. 10;

FIGS. 19A and 19B respectively show top and side views of the sixth component of FIG. 19;

FIG. 20 shows a sectional view, according to the section line XX-XX in FIG. 19A, of the sixth component of FIG. 19;

FIG. 21 shows a side view of the first component and the second component, fixed to each other and connected to the frame of a saddle;

FIG. 22 shows a different embodiment of the third component of an anchoring device according to the present invention, connected to a seatpost; and

FIG. 23 shows a variation of a seatpost which can be combined with the anchoring device according to the present invention.

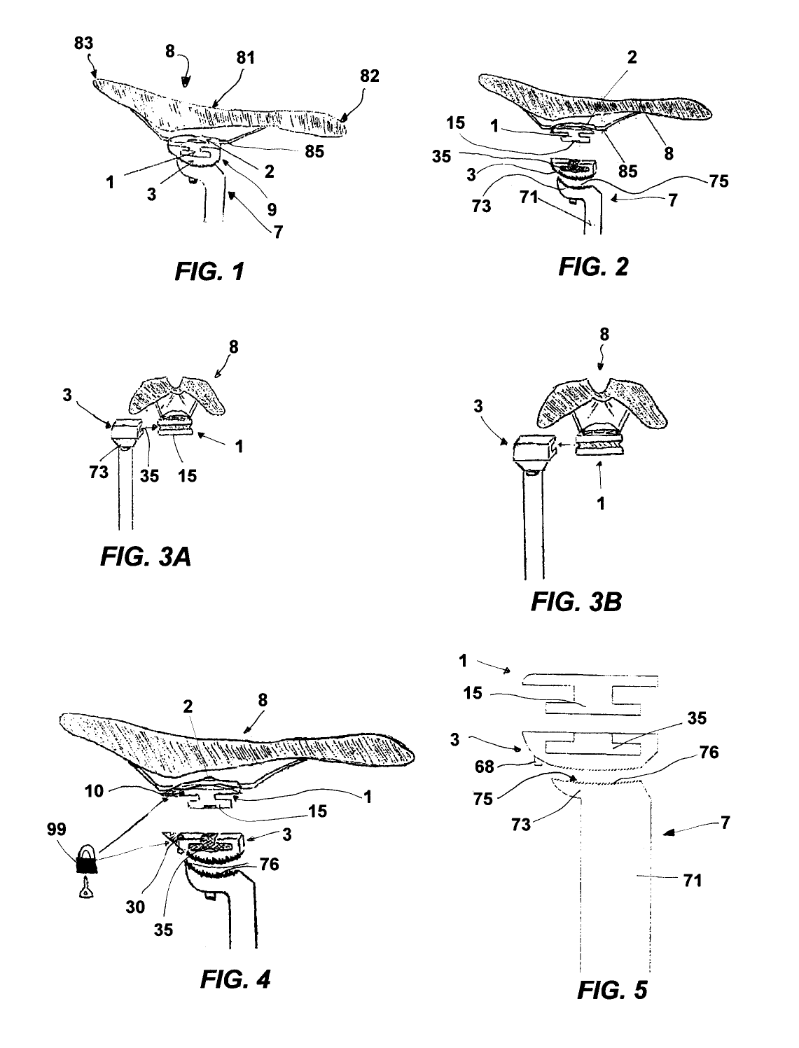

### DETAILED DESCRIPTION OF THE INVENTION

With reference to the accompanying drawings, an embodiment of an anchoring device for anchoring a saddle to a seatpost is denoted by reference number 9.

A saddle 8 for a bicycle comprises a seat 81, having a front part 82 and an enlarged rear part 83, and a support frame which in particular is provided with two bars 85 extending between the front part 82 and the rear part 83.

In the extent of the present invention, the terms “front”, “rear”, “right”, “left”, “top”, “bottom” and other similar terms are to be interpreted in connection with the orientation of bicycle riding direction.

For example, a seatpost 7 comprises a tube 71 and a support bracket 73 for supporting a saddle 8. The seatpost 7, and in particular the support bracket 73, includes a top housing 75 which has a concave shape, in particular it is a portion of a cylindrical surface, and is provided with a knurling 76.

In a first embodiment, an anchoring device 9 comprises a first component 1 adapted to receive the bars 85 of the saddle 8, a second component 2 detachably fixed to the first component 1 for holding a portion of the bars 85 of the saddle 8, a third component 3 detachably fixed to the seatpost 7. The first component 1 and the third component 3 are detachably mounted to each other in a removable manner, as it will be better explained in the following, through a reversible interlocking component of a male-female type, that allows a quick release of the saddle 8 from the seatpost 7.

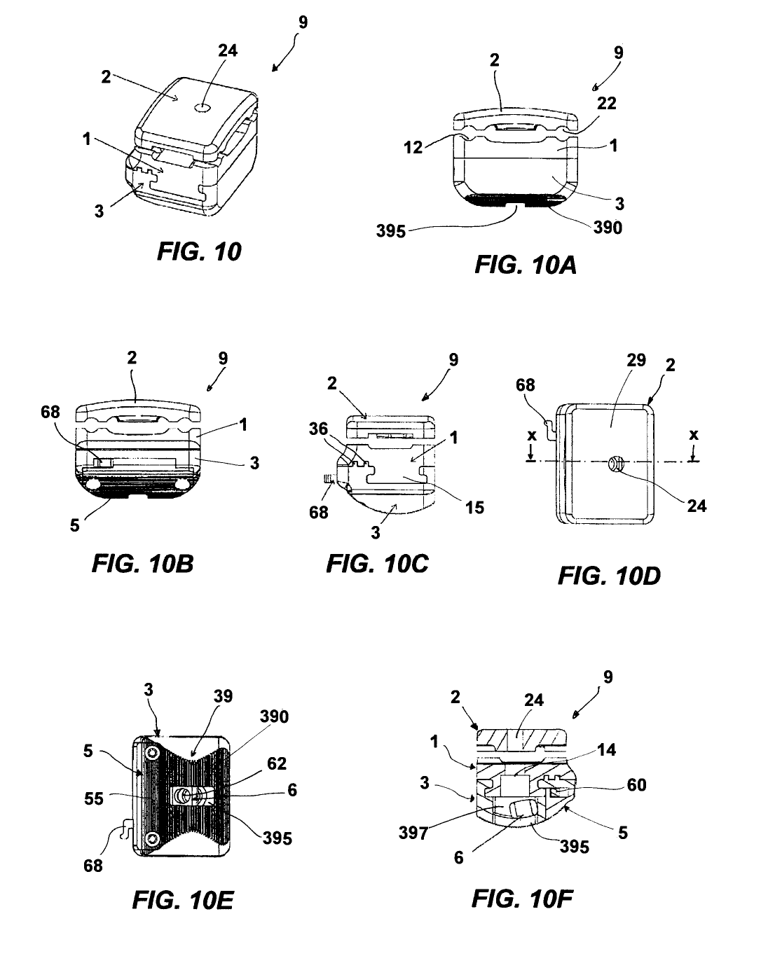

In the following, the embodiment shown in FIGS. 10 to 20 will be described in greater detail.

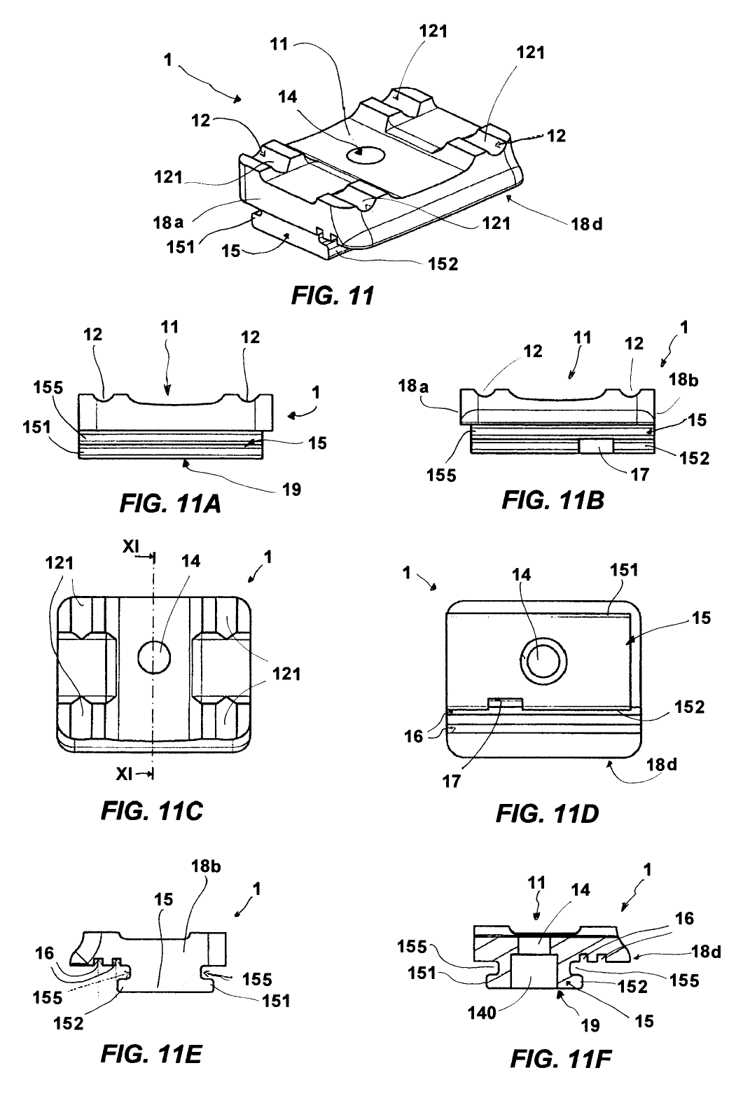

Referring to FIG. 11 to FIG. 11F, the first component 1 is a quick-release male element comprises a first top region 11 on which there are two first grooves 12, in particular the two first grooves 12 which defined four first housings 121 for receiving the bars 85 of the saddle 8. These two first grooves 12 are respectively arranged in the vicinity of a first flank 18a and a second flank 18b of the first component 1.

The first component 1 has a non-threaded central hole 14, that is a housing for a screw (not shown). The central hole 14 is a through hole for connecting the first top region 11 and a first bottom region 19 of the first component 1, and in the first bottom region 19 it comprises an enlarging portion 140 having a diameter larger than the central hole 14 to contain and hide the head of the screw.

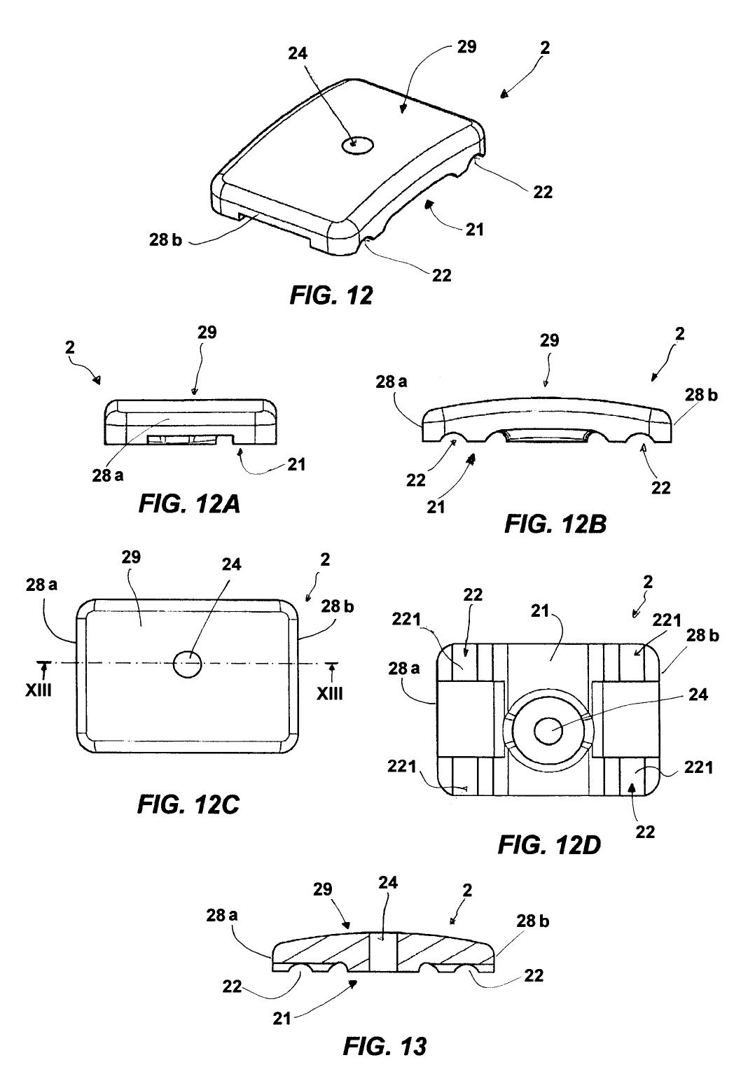

Referring to FIG. 12 to FIG. 13 which show the second component 2 is a saddle coupler comprises a second bottom region 21 on which and has two second grooves 22, in particular these two second grooves 22 define four second housings 221 for receiving the bars 85 of the saddle 8. These two second grooves 22 are respectively arranged in the vicinity of a left flank 28a and a right flank 28b of the second component 2.

Moreover, the second component 2 has, in its central part, a threaded hole 24 adapted to receive a screw. The threaded hole 24 is a through hole connected between the second bottom region 21 and a second top region 29 of the second component 2.

The first component 1 and the second component 2 can be detachably fixed to each other in order to hold the bars 85 of the saddle 8. The bars 85 are housed respectively in the first grooves 12 and the second component 2 is positioned above the bars 85 and the first component 1, so that the bars 85 are positioned respectively in the second grooves 22.

A screw (not shown) is inserted from the first bottom region 19 of the first component 1 into the non-threaded hole 14 and then threaded into the threaded hole 24. The first component 1 and the second component 2 are thus fixed and clamp the bars 85 between them, so as to secure the bars 85 and constrain the saddle 8 to the anchoring device 9. The position of the anchoring device 9 along the frame of the saddle 8 can be suitably adjusted and set.

The first component 1 comprises a male member 15 arranged in the first bottom region 19. In the embodiment of the present invention, the male member 15 has a substantially upside-down T-shape, having a front protrusion defined as a first protrusion 151 and a rear protrusion defined as a second protrusion 152. Respective first grooves 155 are located between these protrusions 151, 152 and the main body of the first component 1. The male member 15 extends between a first flank 18a and a second flank 18b of the first component 1. In other words, the male member 15 extends transversely relative to the back-forth direction defined by the driver riding direction for a certain length, which is almost equal to the width of the first component 1.

Referring to FIG. 11D to FIG. 11F, the first bottom region 19 of the first component 1 is provided with at least one second groove 16 extended between the first flank 18a and the second flank 18b in parallel with the male member 15, in particular between the male member 15 and a rear end 18d. In particular, in the embodiment of the present invention, the first bottom region 19 of the first component 1 has two second grooves 16.

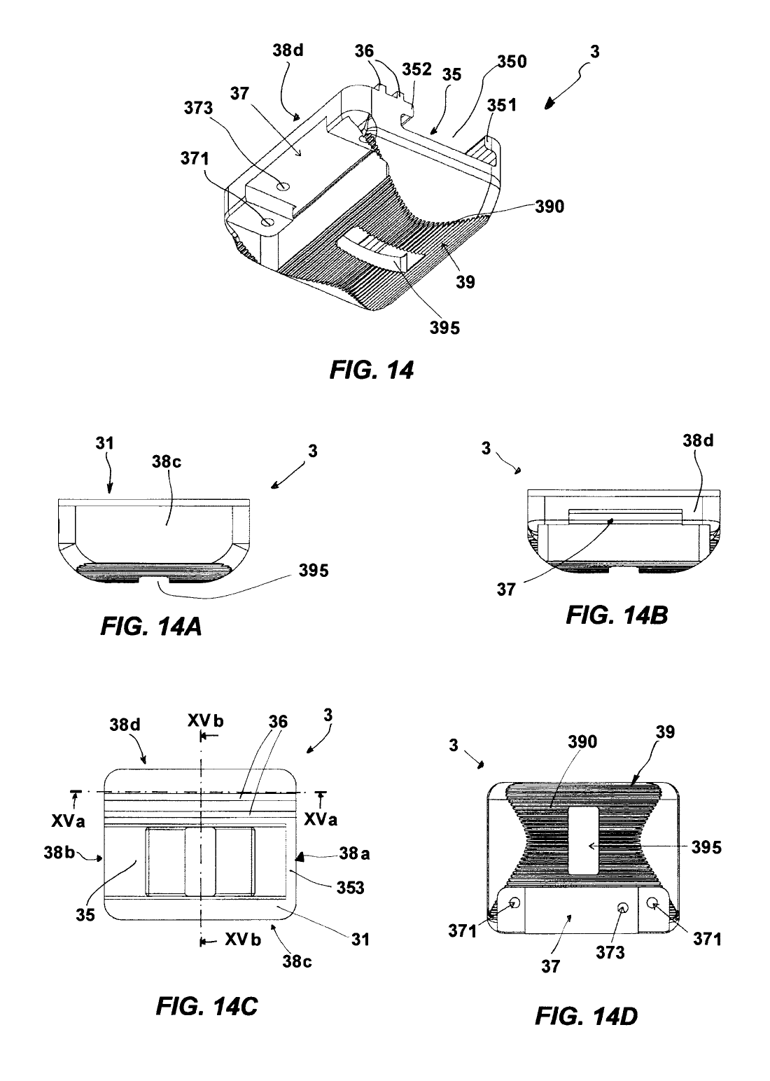

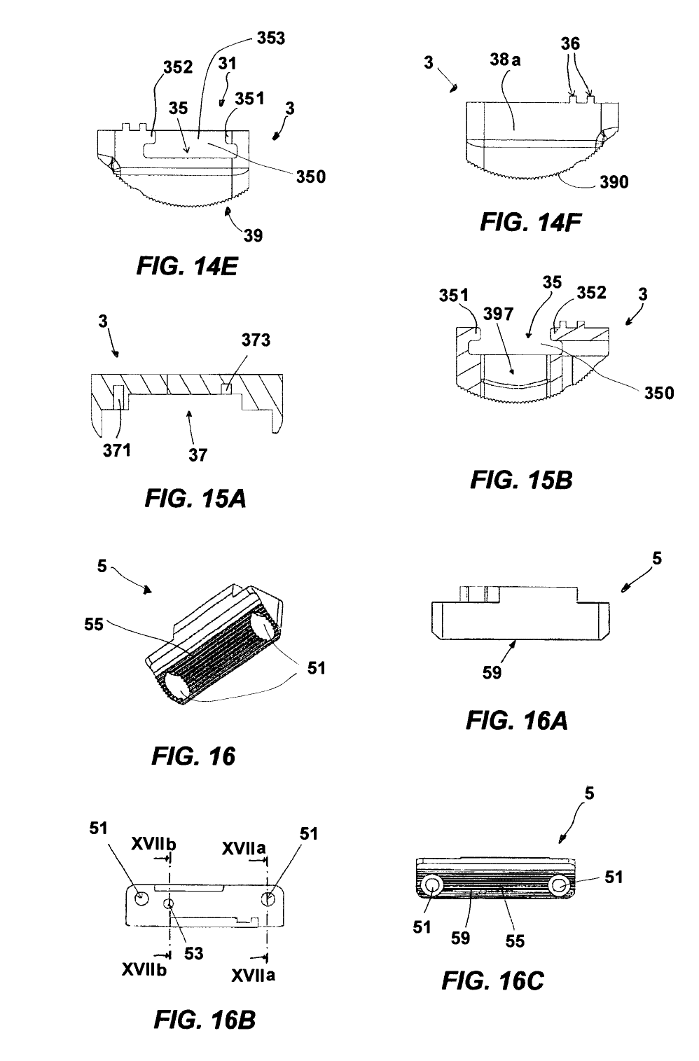

Referring to FIGS. 14 to 14F, the third component 3, or seatpost coupling female element, is adapted to be fixed to a seatpost 7 through fixing means such as a screw. The third component 3 has a third bottom region 39, which has a convex surface. In particular, this convex surface is a portion of a cylindrical surface and is provided with a knurling 390. The bottom portion 39 also has an elongated window 395, which allows access to an inner recess 397 of the third component 3. In particular, a threaded nut 6, having an internally-threaded hole 62 which is accessible from the elongated window 395 of the third bottom region 39, is arranged in the inner recess 397.

Please refer to FIG. 5 again, the third component 3 is configured to be received in the top housing 75 of the seatpost 7, the third bottom region 39 contacting the knurling 76 of the seatpost 7. The degree of curvature of the bottom surface 39 substantially corresponds with the degree of curvature of the knurling 76 of the top housing 75 of the seatpost 7. This arrangement allows to adjust the tilt of the third component 3 and then of the whole saddle 8 relative to the seatpost 7.

Please refer to FIGS. 10E and 10F, once the preferred tilt has been adjusted on the knurling 76, the third component 3 is fixed to the seatpost 7 through a threaded screw (not shown) that anchors the first component 1 to the second component 2.

The fixing threaded screw goes through a corresponding hole (not shown) in the support bracket 73 of the seatpost 7 and through the elongated window 395, engaged with the internally threaded hole 62 of the threaded nut 6. The tightening of the fixing threaded screw fixes the third component 3 on the seatpost 7, keeping the set tilt. In other words, the threaded nut 6 clamps the third component 3 to its seatpost 7.

Referring to FIG. 14, the knurling 390 of the third component 3, as well as the curvature of the bottom region 39 and the knurling 76, allows the adjustment of the tilt of the third component 3 along the knurling 76 of the seatpost 7, and facilitates the keeping of such a tilt preventing a slipping at the same time.

Basically, the assembly comprising the seatpost 7, the anchoring device 9 and the fixing threaded screw is configured to allow the fixing of the third component 3 to the seatpost 7 in a plurality of positions having different mutual tilts.

Please refer to FIGS. 14 to 14D, the third component 3 also comprises a third top region 31, which is provided with a female housing 35 having a shape substantially complementary to the male member 15. Hence such the female housing 35 substantially has an upside-down T-section and extends between a third flank 38a (in particular the right flank) and a fourth flank 38b (in particular the left flank) of the third component 3. The female housing 35 is opened at the top, where it has a section of narrow width due to protrusions 351, 352 that correspond to the first grooves 155 of the male member 15. Below these protrusions 351, 352, the female housing 35 has a section of greater width corresponding to the first protrusions 151 and to the second protrusion 152 of male member 15.

The female housing 35 is therefore shaped for receiving the male member 15. In particular, the female housing 35 has an access opening 350 on one flank (for example the third flank 38a), which allows the male member 15 to access the female housing 35 and to enter the female housing 35 itself. On the other side of the female housing 35, i.e. on the other flank (for example the fourth flank 38b), is provided with a solid end-of-stroke wall 353, which is adapted to restrain and block the male member 15 of the first component 1 from one side. In other words, the female housing 35 is open on the fourth flank 38b, where the access opening 350 is located, and it is not open on the third flank 38a, where the end-of-stroke wall 353 is located.

The first component 1, with the male member 15, fits on the third component 3 with the female housing 35. The first component 1 and the third component 3 are then detachably mounted to each other, forming an interlocking system of a male-female type.

Please refer to FIG. 8A to 9B, the T-shape of the male member 15, thanks to the first protrusion 151 and the second protrusion 152, is useful for making a secure connection and ensuring that, during use of the bicycle, the first component 1 and the third component 3 behave as if they were a single piece, avoiding unwanted relative movements. The stability of the connection is enhanced by the fact that the male member 15 and the female housing 35 extend along a considerable length, which is equal to or almost equal to the width of the respective the first component 1 or the third component 3 between the first flank 18a and the second flank 18b or the third flank 38a and the fourth flank 38b.

The mounting is of a detachable type, in fact the interlocking is reversible by means of a relative sliding of the first component 1 with respect to the third component 3 in a direction of extraction of the male member 15 from the female housing 35. Consequently, the interlocking system allows a quick release of the saddle 8 from the seatpost 7.

In particular, the relative sliding is on a plane which is transversal to the tube 71, i.e. on a plane substantially horizontal or parallel to the seat 81. This allows to avoid that the weight of the user seated on the saddle 8 may cause an unintentional sliding.

As shown in FIGS. 3A and 3B, the release of the saddle 8 from the seatpost 7 or the anchoring of the saddle 8 to the seatpost 7 takes place through a slipping or sliding of the first component 1 relative to the third component 3 along a right-left direction, i.e. transversally with respect to the saddle 8 (i.e. transversal to the front part 82 to the rear part 83 direction of the saddle 8). This is useful for reducing the risk of an unintentional release during the use of the bicycle.

Please refer to FIG. 14 to FIG. 14D again, in the third top region 31 of the third component 3, in particular between the female housing 35 and the rear region 38d, at least one rib 36 is provided, which extends between the third flank 38a and the fourth flank 38b in parallel with the female housing 35. In particular, in the embodiment shown, two ribs 36 are provided. The ribs 36 have shapes which are complementary to the shapes of the second grooves 16 of the first component 1, and are arranged in positions corresponding to the second grooves 16. In fact, these elements are intended to engage with each other during the sliding of the male member 15 along the female housing 35.

The second grooves 16 and the ribs 36 are simple holding guides for easing the stress acting on the protrusions 151, 152 and on the first grooves 155 of the male member 15, as well as to facilitate the mutual sliding of the first component 1 relative to the third component 3.

The anchoring device 9 also comprises a fastening system that allows to fasten the first component 1 and the third component 3 to each other, when these are in the mounted configuration.

Please refer to FIG. 10B to 10E and FIG. 18 to 18B, in particular, a fastening system is configured for fastening the first component 1 and the third component 3 to each other at an end-of-stroke position of the reversible interlocking component. The fastening system further comprises a control portion 68 for releasing the fastening between the first component 1 and the third component 3, thus allowing the quick release.

In detail, the fastening system comprises a fastening member 60 mounted on the third component 3. The fastening member 60 has a pivoting seat 65 for receiving a pivot pin (not shown) to pivot to the third component 3. In particular the fastening member 60 is pivoted in a receiving portion 37 of the third component 3 shown in FIG. 14.

The fastening member 60 has an engaging portion 64, which is configured to engage with the first component 1 in the end-of-stroke position, i.e. when the male member 15 is fully inserted into the female housing 35. Specifically, this engagement takes place through a protruding portion of the engaging portion 64, which moves into a recess 17 made in the second protrusion 152 of the male member 15.

The engaging portion 64 is pushed towards the second protrusion 152 of the male member 15 by a compression spring (not shown, for example being 4 mm×10 mm in size) which is partially housed in a cavity 66 of the engaging portion 64. The engaging portion 64, in the part facing the male member 15, has a ramp-shaped profile on one side and an abutment on the other side, so as to allow the sliding of the male member 15 in a direction from the ramp-shaped side toward the abutment side, and to block the sliding in a direction from the abutment side toward the ramp-shaped side.

The control portion 68 protrudes from the rear region 38d of the third component 3, and then can be operated by the user to unfasten the first component 1. In fact, a push on the control portion 68 moves the engaging portion 64 out from the recess 17, thus allowing the slipping of the first component 1 from the third component 3.

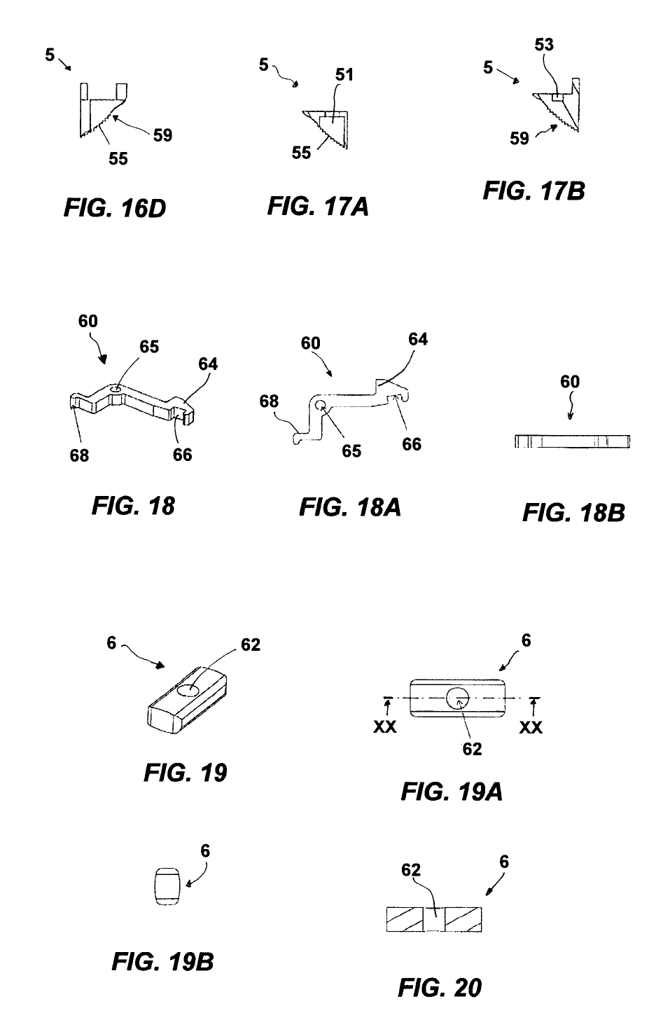

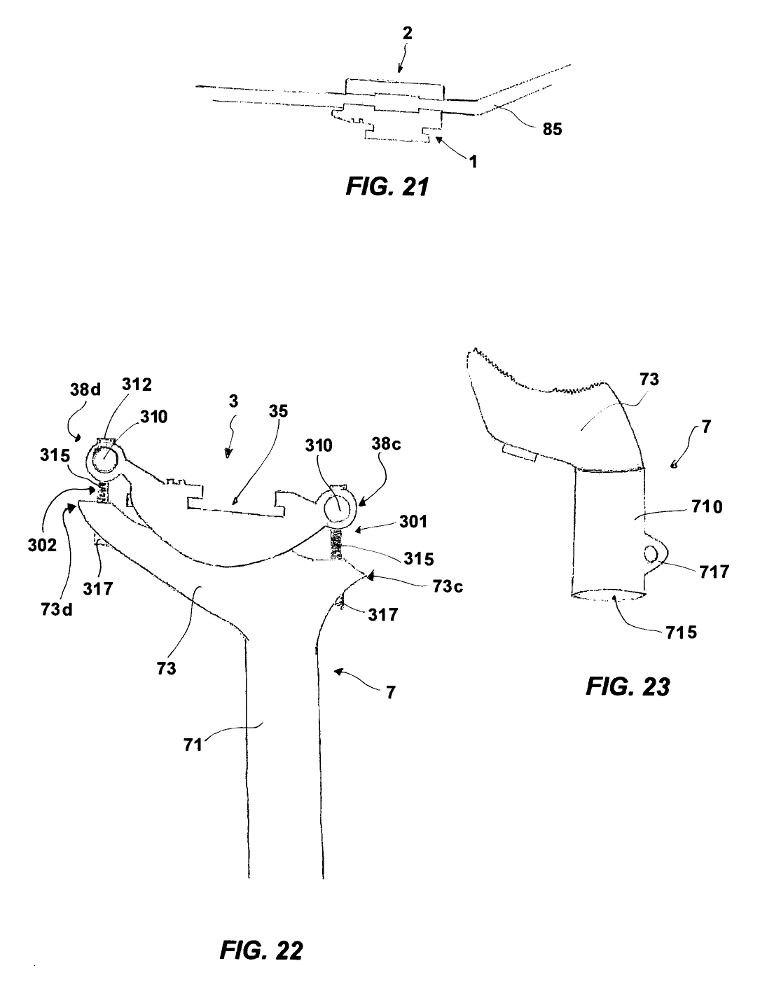

Please refer to FIG. 16 to FIG. 17B, the anchoring device 9 also comprises a cover 5 for the receiving portion 37 for the fastening member 60. The fastening member 60 and, specifically, the engaged portion 64 are arranged inside the cover 5.

The cover 5 is fixed to the third component 3 by means of small screws inserted into seats 51 in the cover 5 and screwed into threaded holes 371 at the ends of the receiving portion 37. The cover 5, internally, also has a First pivot seat 53 for an end of the pivot pin of the fastening member 60; the other end of the pin is received in a second pivot seat 373 in the receiving portion 37.

In a bottom region 59, the cover 5 comprises a knurled surface 55 that, when the cover 5 is mounted on the third component 3, forms a continuation of the knurling 390 of the third member 3 and has the same features thereof.

When the user needs to remove the saddle 8, for example because he/she has to leave the bicycle unattended and fears the theft of the saddle 8, he/she pushes the control portion 68, releasing the engaging portion 64 from the recess 17, and removes the first component 1 from the third component 3 by making it sliding from left to right, until the male member 15 completely exits out from the female housing 35.

Hence the saddle 8 has been released in a simple and quick way; the user can decide whether either to carry the saddle 8 with him/her (obviously, the first component 1 and the second component 2 stay fixed to the saddle 8) or to secure it to a bike rack via a chain padlock, through the bars 85 of the saddle 8 itself, together with the bicycle.

The subject of the present invention can also be applied to seatposts of a professional type. For example, a version that allows a more accurate adjustment of the tilt of the saddle 8 is shown in FIG. 22.

The third component 3, which is substantially similar to the embodiment already described above in the aspects not described below, is provided with a first adjustment screw member 301, which is associated with a front region 38c of the third component 3, and with a second adjustment screw member 302, which is associated with a rear region 38d of the third component 3.

Basically, each of these adjustment members 301, 302 comprises a pin 310 pivoted to the respective region 38c, 38d and having a threaded transversal hole 312, in which a screw 315 with a head 317 is screwed. Each head 317 engages with a front portion 73c or a rear portion 73d of the seatpost 7.

Therefore, each adjustment member 301, 302 connects the front or rear region 38c,38d of the third component 3 to a respective front or rear portion 73c, 73d of the seatpost 7. Acting on each screw 315, the distance between the respective region 38c, 38d of the third component 3 and the respective portion 73c, 73d of the seatpost 7 can be adjusted, thus varying the tilt of the third component 3 relative to the seatpost 7. Thanks to the small pitch of the screws 315, the tilt adjustment can be done in a very accurate manner.

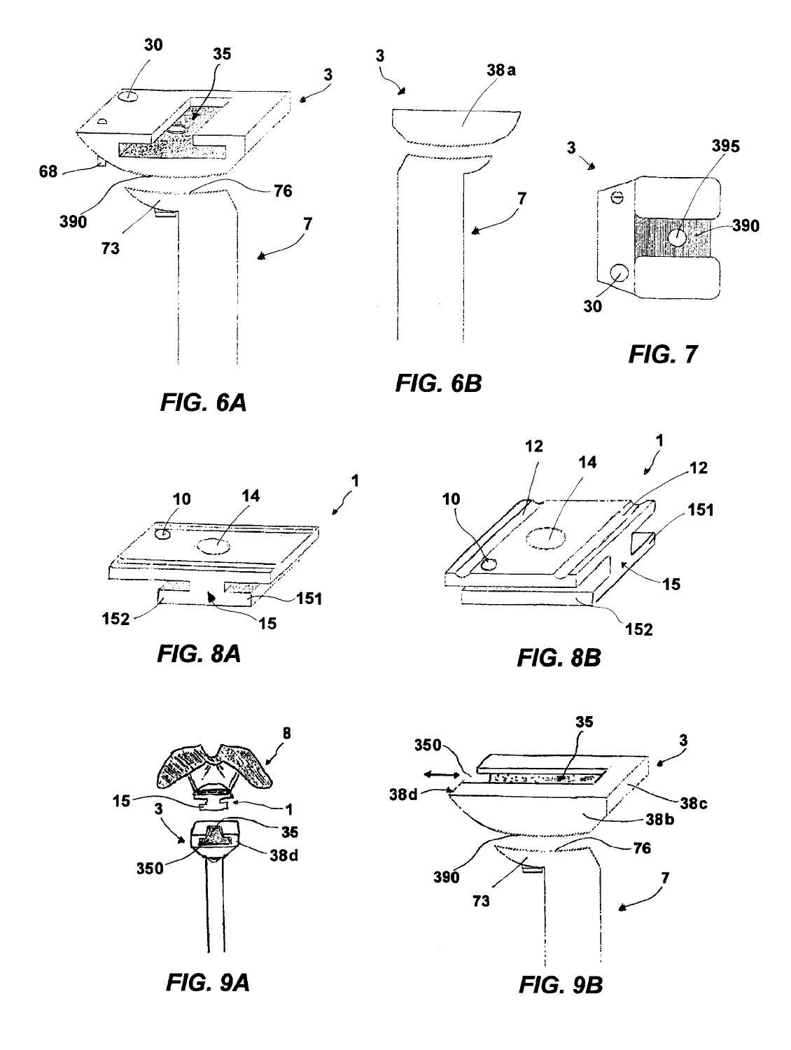

In a different embodiment, shown in FIGS. 4 to 8, the first component 1 is provided with a through hole 10 and the third component 3 is provided with a corresponding through hole 30; these through holes 10, 30 are aligned with each other when the first component 1 is mounted on the third component 3 (i.e., at the end of stroke), and allow the insertion of a padlock 99 through them. In this way, when the bicycle is unattended, the release and the removal of the first component 1 from the third component 3 (and then the theft of the saddle 8) are prevented.

In an alternative embodiment, shown in FIGS. 9A and 9B only, the female housing 35 is turned so as to extend between the rear region 38d and the front region 38c of the third component 3. In particular, its access opening 350 is at the rear region 38d. In other words, the female housing 35 is revolved of 90° relative to the embodiment described hereto. The male member 15 is similarly revolved of 90°. Thus the release/anchoring takes place via a sliding of the first component 1 relative to the third component 3 along a back-forth direction, i.e. parallel to the saddle 8 and its front part 82 to rear part 83 direction.

The access opening 350 to the female housing 35 is at the rear region 38d of the third component 3 (as shown in FIGS. 9A and 9 B), or, in a different embodiment, the access opening 350 can be at the front region 38c of the third component 3.

In particular, an implementation can be found in a public gym equipped with gymnastic apparatuses like exercise bikes, spin bikes, or hydro-bike, in order to allow each user to have his/her own individual and customized saddle to be mounted each time on a gymnastic apparatus and to be removed at the end of the use of the apparatus.

For example, an accessory for facilitating such an implementation is shown in FIG. 23.

The seatpost 7 comprises a tubular portion 710, of limited length and having an inner diameter, which defines an inner housing 715 for receiving an end of a support pillar of an exercise bike, a spin bike, or a hydro-bike. The seatpost 7 can then be engaged on the pillar end in order to make the anchoring device 9 compatible with the gymnastic apparatus.

The tubular portion 710 may have a longitudinal cutting, such as to be elastically deformable to allow a widening of the inner housing 715 during the engagement on the support pillar, thus making the mounting easier. At the edges of the longitudinal cutting, the tubular portion 710 is provided with tabs 717 having a through hole to allow a tightening via a bolt, which brings closer the tabs 717 and the edges of the cutting, so gripping on the support pillar. In this way, the seatpost 7 can be adjusted and tightened on support pillars of the gymnastic apparatuses having a diameter which does not exactly match with the diameter of the inner housing 715, so making the anchoring device 9 usable on the gymnastic apparatuses as well.

The subject of the present invention has been described hitherto with reference to preferred embodiments thereof. It is understood that other embodiments relating to the same inventive idea may exist, all of these falling within the scope of protection of the claims which are provided hereinbelow.

1. An anchoring device (9) for anchoring a bicycle saddle (8) to a seatpost (7), comprising a first component (1) adapted to receive a frame (85) of a saddle (8), a second component (2) fixable on the first component (1) for holding a portion of the frame (85) of the saddle (8), and a third component (3) adapted to be fixed to a seatpost (7),
wherein the first component (1) and the third component (3) are removably mountable to each other,
the first component (1) and the third component (3) forming a reversible interlocking system of a male-female type (15, 35), which allows a quick release of the saddle (8) from the seatpost (7).

2. The anchoring device (9) according to claim 1, wherein the reversible interlocking system is configured to allow a release/anchoring of the saddle (8) from/to the seatpost (7) through a sliding of the first component (1) relative to the third component (3)

3. The anchoring device (9) according to claim 2, wherein said sliding is along a right-left direction or along a back-forth direction.

4. The anchoring device (9) according to claim 1, 2 or 3, wherein the first component (1) is the male element (15) of the interlocking system and the third component (3) is the female element (35) of the interlocking system.

5. The anchoring device (9) according to claim 4, wherein the first component (1) comprises a top region (11, 14) for fixing the second component (2) and a male member (15) arranged in a bottom region (19) of the first component (1), the male member (15) substantially having an upside-down T-section which has a first protrusion (151) and a second protrusion (152), the male member (15) extending between a first flank (18a) and a second flank (18b) of the first component (1),
and wherein the third component (3) comprises a top region (31) provided with a female housing (35) for receiving said male member (15), said female housing (35) being substantially complementary to said male member (15), an access opening (350) to said female housing (35) for said male member (15) being arranged on a first flank (38a) and/or a second flank (38b) of the third component (3),
the male member (15) being slidable along said female housing (35) in parallel to a top face (31) of the third component (3) for allowing a release/anchoring between the first component (1) and the third component (3).

6. The anchoring device according to claim 1, 2 or 3, wherein the third component (3) comprises a top region (31) provided with a male member, the male member substantially having a T-section which has a first protrusion and a second protrusion, the male member extending between a first flank (38a) and a second flank (38b) of the third component (3),
and wherein the first component (1) comprises a top region (11, 14) for fixing the second component (2) and a bottom region (19) provided with a female housing for receiving said male member, said female housing being substantially complementary to said male member, an access opening to said female housing for said male member being arranged on a first flank (18a) and/or a second flank (18b) of the first component (1),
the male member being slidable along said female housing in parallel to a bottom face (19) of the first component (1) for allowing a release/anchoring between the first component (1) and the third component (3).

7. The anchoring device (9) according to claim 5 or 6, wherein said first flank and second flank are respectively a left flank (18a, 38a) and a right flank (18b, 38b), or vice versa, and wherein said first protrusion is a front protrusion (151) and said second protrusion is a rear protrusion (152).

8. The anchoring device (9) according to any one of claims 5 to 7, wherein one of the first component (1) and the third component (3) comprises at least one groove (16) which extends between the first flank (18a, 38a) and the second flank (18b, 38b), and the other of the first component (1) and the third component (3) comprises at least one corresponding rib (36) which extends between the first flank (38a, 18a) and the second flank (38b, 18b), wherein the groove (16) and the rib (36) are intended to engage with each other during the sliding of the male member (15) along said female housing (35), the groove (16) and the rib (36) being parallel to the respective one of the male member (15) and the female housing (35).

9. The anchoring device (9) according to any one of claims 1 to 8, comprising a snap-pin system (60) configured for fastening the first component (1) and the third component (3) to each other in a mounted configuration, at an end-of-stroke position of the reversible interlocking system, the snap-pin system (60) further comprising a button (68) for releasing the fastening between the first component (1) and the third component (3).

10. The anchoring device (9) according to any one of claims 1 to 9, comprising a fastening system for fastening the first component (1) and the third component (3) to each other in a mounted configuration, the fastening system including a movable member (60) mounted on one of the first component (1) and the third component (3), wherein the movable member (60) includes a first engaging portion (64) which is configured for engaging with the other of the first component (1) and the third component (3) at an end-of-stroke position of the reversible interlocking system, and a second control portion (68) which is accessible to a user to control the engagement/disengagement of the first engaging portion (64).

11. The anchoring device (9) according to claim 10, wherein said movable member is lever-shaped (60) and is pivoted to said one of the first component (1) and the third component (3).

12. The anchoring device (9) according to claim 9, 10 or 11, wherein said button or said second control portion (68) protrudes from a rear region (38d) of the third component (3).

13. The anchoring device (9) according to any one of claims 9 to 12, wherein the snap pin or the movable member (60) is arranged in a seating (37), the anchoring device (9) further comprising a cover (5) for said seating (37).

14. The anchoring device (9) according to any one of claims 1 to 13, wherein both the first component (1) and the third component (3) are provided with a respective through hole (10, 30), said through holes (10, 30) being aligned with each other when the first component (1) and the third component (3) are in a mounted configuration, the alignment of said through holes (10, 30) allowing the insertion of a padlock (99) to prevent a release of the first component (1) from the third component (3).

15. The anchoring device (9) according to any one of claims 1 to 14, comprising a threaded nut (6) arranged in an inner recess (397) of the third component (3) and having an internally-threaded hole (62) which is accessible from an elongated window (395) of a bottom portion (39) of the third component (3), said threaded nut (6) being intended to cooperate with fixing means for fixing the third component (3) to the seatpost (7).

16. The anchoring device (9) according to any one of claims 1 to 15, wherein the third component (3) has a bottom surface (39) which is convex and provided with a knurling (390) to allow an adjustment of a tilt of the third component (3) relative to the seatpost (7).

17. The anchoring device (9) according to claim 16, wherein the third component (3) comprises a first adjustment screw member (301) and a second adjustment screw member (302), the first adjustment member (301) being associated with a front region (38c) of the third component (3) and the second adjustment member (302) being associated with a rear region (38d) of the third component (3), said adjustment members (301, 302) being configured to cooperate with a seatpost (7) to adjust a tilt of the third component (3) relative to the seatpost (7).

18. An assembly comprising an anchoring device (9) according to any one of claims 1 to 17, a seatpost (7) and fixing means, wherein the third component (3) is fixed to the seatpost (7) through said fixing means.

19. The assembly according to claim 18 when dependent on claim 16 or 17, wherein the seatpost (7) comprises a top housing (75) having a concave shape and provided with a knurling (76), said top housing (75) being adapted to receive the convex bottom surface (39) of the third component (3), wherein the assembly is configured to allow the fixing of the third component (3) to the seatpost (7) in a plurality of positions having different mutual tilts.

20. The assembly according to claim 19 when dependent on claim 17, wherein the first adjustment member (301) connects a front region (38c) of the third component (3) to a front portion (73c) of the seatpost (7), and the second adjustment member (302) connects a rear region (38d) of the third component (3) to a rear portion (73d) of the seatpost (7), each of said adjustment members (301, 302) being configured to adjust a distance between the respective region (38c, 38d) of the third component (3) and the respective portion (73c, 73d) of the seatpost (7).

21. The assembly according to claim 18, 19 or 20, wherein the seatpost (7) comprises a tubular portion (710) having an inner receiving housing (715) for receiving a support pillar.

22. A seating system for a bicycle or the like, comprising an anchoring device (9) according to any one of claims 1 to 17 or an assembly according to any one of claims 18 to 21, the seating system further comprising a saddle (8), wherein the saddle (8) includes a frame (85), a portion of the frame (85) being held between the first component (1) and the seconds component (2).

23. A bicycle or the like, comprising an assembly according to any one of claims 18 to 21, or a seating system according to claim 22.
